(19) United States
(12) Patent Application Publication
(10) Pub. No.: US 2011/0232425 A1
(43) Pub. Date: Sep. 29, 2011

(54) Folding Tool

(76) Inventors: Maan-Jyi Chang, We-Jih Hsiang (TW); Paul Chang, Changhua County (TW)

(21) Appl. No.: 12/731,360

(22) Filed: Mar. 25, 2010

(51) Int. Cl. B25B 13/46; B25B 15/04; B25B 23/16

(52) U.S. Cl. 81/63.1; 81/439; 81/450; 81/177.4

(57) ABSTRACT

A folding tool includes two support plates, a ratchet driver pivotally mounted between the two support plates, a rotation seat rotatably mounted between the two support plates, and a plurality of tips each removably mounted on the rotation seat and each detachably mounted on the ratchet driver. The ratchet driver drives each of the tips to rotate in the operation direction only and idles in the opposite direction so that each of the tips can rotate the screw member in the operation direction successively so as to screw or unscrew the screw member easily and quickly. Thus, when the folding tool is used in a smaller space, each of the tips is driven by the ratchet driver to rotate the screw member in the operation direction successively and to screw or unscrew the screw member easily and quickly.

### BACKGROUND OF THE INVENTION

1. Field of the Invention

The present invention relates to a hand tool and, more particularly, to a folding tool.

2. Description of the Related Art

A conventional folding tool 1 in accordance with the prior art shown in FIG. 1 comprises two support plates 11 and 12 spaced from each other, and a plurality of drivers 13 each pivotally mounted between the two support plates 11 and 12. Each of the drivers 13 is a hex wrench and the like. When in user, one of the drivers 13 is pivoted outwardly from the two support plates 11 and 12 and is mounted on a screw member, such as a screw and the like. Thus, the driver 13 can be driven to rotate the screw member so as to screw or unscrew the screw member. However, when the folding tool 1 is operated in a smaller space, each of the drivers 13 cannot rotate the screw member easily and quickly, thereby causing inconvenience to the user when operating the folding tool 1 in the smaller space.

Another conventional folding tool 2 in accordance with the prior art shown in FIG. 2 comprises two support plates 21 and 22 spaced from each other, a driver 23 pivotally mounted between first ends of the two support plates 21 and 22, a receiving seat 24 pivotally mounted between second ends of the two support plates 21 and 22, and a plurality of tips 25 each removably mounted on the receiving seat 24 and each detachably mounted on the driver 23. When in user, one of the tips 25 is removed from the receiving seat 24 and is mounted on the driver 23. In such a manner, when the tip 25 is mounted on a screw member, such as a screw and the like, the tip 25 is driven by the driver 23 to rotate the screw member so as to screw or unscrew the screw member. However, when the folding tool 2 is operated in a smaller space, each of the drivers 23 cannot rotate each of the tips 25 easily and quickly, thereby causing inconvenience to the user when operating the folding tool 2 in the smaller space.

### BRIEF SUMMARY OF THE INVENTION

In accordance with the present invention, there is provided a folding tool, comprising two support plates spaced from each other, a ratchet driver pivotally mounted between first ends of the two support plates, a rotation seat rotatably mounted between second ends of the two support plates, and a plurality of tips each removably mounted on the rotation seat and each detachably mounted on the ratchet driver.

The primary objective of the present invention is to provide a folding tool that is used to operate a screw member in a smaller space easily and quickly.

According to the primary objective of the present invention, the ratchet driver drives each of the tips to rotate in the operation (clockwise or counterclockwise) direction only and idles in the opposite direction so that each of the tips can rotate the screw member in the operation direction successively so as to screw or unscrew the screw member easily and quickly.

According to another objective of the present invention, when the folding tool is used in a smaller space, each of the tips is driven by the ratchet driver to rotate the screw member in the operation direction successively and to screw or unscrew the screw member easily and quickly, thereby greatly facilitating the user operating the folding tool in the smaller space.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional folding tool in accordance with the prior. art.

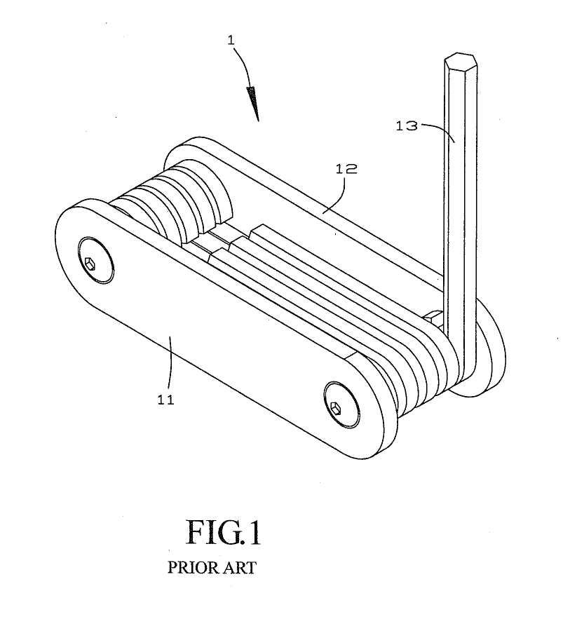

FIG. 2 is a perspective view of another conventional folding tool in accordance with the prior art.

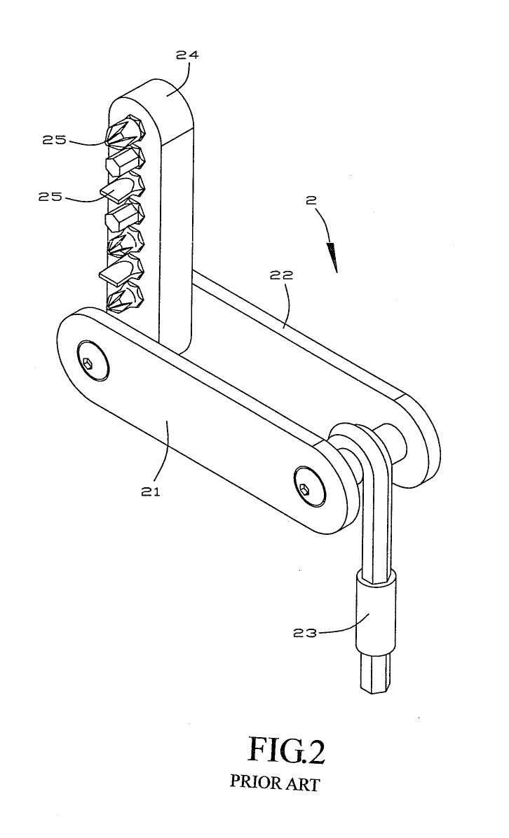

FIG. 3 is a perspective view of a folding tool in accordance with the preferred embodiment of the present invention.

FIG. 4 is a schematic operational view of the folding tool as shown in FIG. 3.

### DETAILED DESCRIPTION OF THE INVENTION

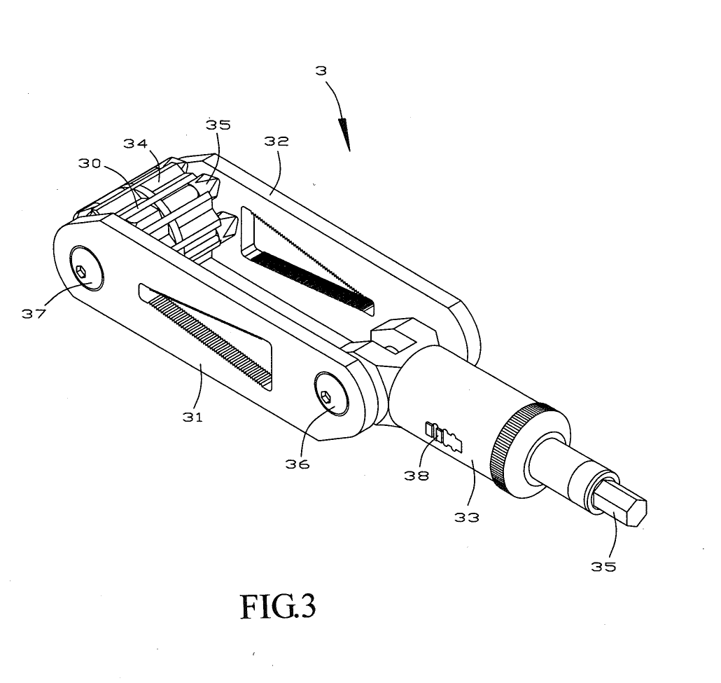

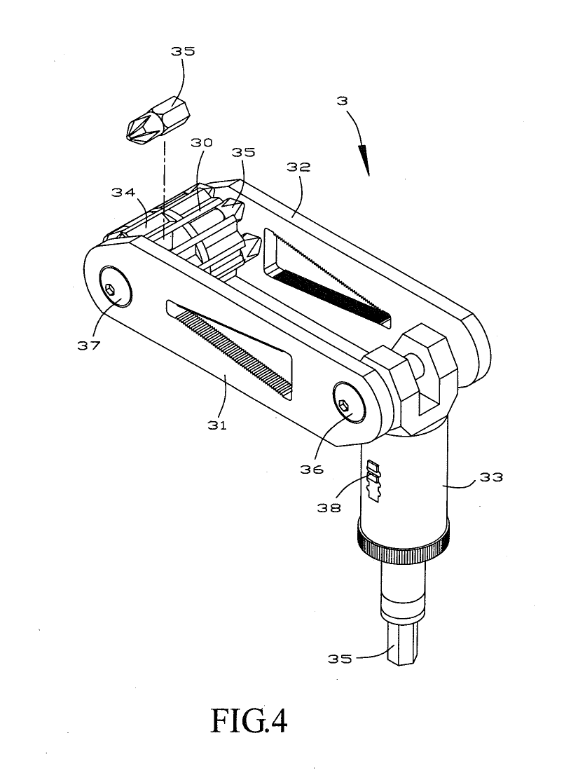

Referring to FIGS. 3 and 4, a folding tool 3 in accordance with the preferred embodiment of the present invention comprises two support plates 31 and 32 spaced from each other, a ratchet driver 33 pivotally mounted between first ends of the two support plates 31 and 32, a rotation seat 30 rotatably mounted between second ends of the two support plates 31 and 32, and a plurality of tips 35 each removably mounted on the rotation seat 30 and each detachably mounted on the ratchet driver 33.

The ratchet driver 33 is pivotally mounted between the first ends of the two support plates 31 and 32 by a pivot member 36.

The ratchet driver 33 is adapted to drive each of the tips 35 to rotate in a single operation direction only. The ratchet driver 33 is provided with a control switch 38 to select the operation direction of the ratchet driver 33. Thus, the ratchet driver 33 can drive each of the tips 35 to rotate in the clockwise direction only or to rotate in the counterclockwise direction only by control of the control switch 38. The tips 35 has a different specifications and sizes.

The rotation seat 30 is rotatably mounted between the second ends of the two support plates 31 and 32 by a pivot element 37. The rotation seat 30 is rotatable about the pivot element 37 so that the pivot element 37 functions as a rotation center of the rotation seat 30. The rotation seat 30 has a circular shape and has a periphery formed with a plurality of receiving grooves 34 to receive the tips 35. The rotation seat 30 is fully received between the two support plates 31 and 32 so that the rotation seat 30 does not protrude outwardly from the two support plates 31 and 32 during rotation of the rotation seat 30.

In operation, the rotation seat 30 is rotatable about the pivot element 37 to expose each of the tips 35 to facilitate the user selecting the tips 35. Then, one of the tips 35 is removed from the rotation seat 30 and is mounted on the ratchet driver 33. In such a manner, when the tip 35 is mounted on a screw member, such as a screw and the like, the tip 35 is driven by the ratchet driver 33 to rotate the screw member so as to screw or unscrew the screw member. Thus, the ratchet driver 33 drives the tip 35 to rotate in the operation (clockwise or counterclockwise) direction only and idles in the opposite direction so that the tip 35 can rotate the screw member in the operation direction successively so as to screw or unscrew the screw member easily and quickly.

Accordingly, the ratchet driver 33 drives each of the tips 35 to rotate in the operation (clockwise or counterclockwise) direction only and idles in the opposite direction so that each of the tips 35 can rotate the screw member in the operation direction successively so as to screw or unscrew the screw member easily and quickly. In addition, when the folding tool 3 is used in a smaller space, each of the tips 35 is driven by the ratchet driver 33 to rotate the screw member in the operation direction successively and to screw or unscrew the screw member easily and quickly, thereby greatly facilitating the user operating the folding tool 3 in the smaller space.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A folding tool, comprising:
two support plates spaced from each other;
a ratchet driver pivotally mounted between first ends of the two support plates;
a rotation seat rotatably mounted between second ends of the two support plates; and
a plurality of tips each removably mounted on the rotation seat and each detachably mounted on the ratchet driver.

2. The folding tool of claim 1, wherein the ratchet driver is pivotally mounted between the first ends of the two support plates by a pivot member.

3. The folding tool of claim 1, wherein the rotation seat is rotatably mounted between the second ends of the two support plates by a pivot element.

4. The folding tool of claim 3, wherein
the rotation seat is rotatable about the pivot element;
the pivot element functions as a rotation center of the rotation seat.

5. The folding tool of claim 1, wherein the rotation seat has a circular shape.

6. The folding tool of claim 1, wherein the rotation seat has a periphery formed with a plurality of receiving grooves to receive the tips.

7. The folding tool of claim 1, wherein the rotation seat is fully received between the two support plates.

8. The folding tool of claim 7, wherein the rotation seat does not protrude outwardly from the two support plates during rotation of the rotation seat.

9. The folding tool of claim 1, wherein the ratchet driver is adapted to drive each of the tips to rotate in a single operation direction only.

10. The folding tool of claim 1, wherein the ratchet driver is provided with a control switch to select the operation direction of the ratchet driver.
